(19) United States
(12) Patent Application Publication
(10) Pub. No.: US 2006/0082825 A1
(43) Pub. Date: Apr. 20, 2006

(54) Print-data processing apparatus for processing print-data to print in correspondence with print-mode set on connected printing device and method thereof

(75) Inventor: Seung-don Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/250,410

(22) Filed: Oct. 17, 2005

(30) Foreign Application Priority Data
Oct. 19, 2004 (JP) 2004-83481

(51) Int. Cl. G06F 3/12

(52) U.S. Cl. 358/1.15

(57) ABSTRACT

An apparatus for processing print-data according to a print-mode set on a connected printing device in order to print the print-data according to the print-mode and a method thereof are disclosed. The print-data processing method includes the steps of: a) setting a print-mode; b) receiving the print-mode; c) performing a predetermined transforming process on the print-data according to the received print-mode; and d) transmitting the transformed print-data to the printing device. Accordingly, the printing device is prevented from performing a faulty printing process caused by the print-data transforming process.

### CROSS-REFERENCE TO RELATED APPLICATIONS

This application claims the benefit under 35 U.S.C. §119(a) of Korean Patent Application No. 2004-83481, filed on Oct. 19, 2004, in the Korean Intellectual Property Office, the entire disclosure of which is hereby incorporated by reference.

### BACKGROUND OF THE INVENTION

1. Field of the Invention

The present invention is related to an apparatus for processing print-data and a method thereof. More particularly, the present invention is related to an apparatus for processing print-data according to a print-mode set on a connected printing device and a method thereof.

2. Description of the Related Art

A printing system includes at least one personal computer (PC) and at least one printing device connected to the PC through a local area network (LAN). The printing system prints print-data by transmitting the print-data stored in the PC to the printing device and printing the print-data at the printing device. Since the printing system provides an advantageous way to effectively share a limited resource with many users, the printing system is very popular.

In a typical printing system, a printing device prints print-data received from a PC as it is or prints the print-data after performing a predetermined data-transforming process. The data-transforming process of the print-data is performed according to a print-mode set on the printing device.

For example, when a toner save mode is set on the printing device as a print-mode, the printing device performs a data-transforming process for reducing the number of dots of the print-data and prints the transformed print-data. Accordingly, a toner of the printing device may be saved by using the toner save mode.

Since the data-transforming process for the toner save mode is a comparatively simple process to a processor of the printing device, there is not much processing load imposed on the processor of the printing device.

However, other print-modes often require the processor of the printing device to perform mass computations for transforming the print-data in order to print the print-data according to print-modes. In this case, a high processing load is imposed on the processor of the printing device. Therefore, when the printing device sets a print-mode requiring mass computation, the printing device may erroneously perform a printing operation or may not timely perform the printing operation.

Furthermore, there is significant chance that the printing device receives a plurality of print-data from several PCs simultaneously because the printing device must print print-data transmitted from several PCs. In this case, if a print-mode requiring mass computation is set on the printing device, it is more difficult for the printing device to perform the printing-operation successfully.

### SUMMARY OF THE INVENTION

Accordingly, the embodiments of the present invention are able to solve the above-mentioned and other problems, and an aspect of the invention is to provide an apparatus for processing print-data in correspondence with a print-mode set on a printing device and a method thereof.

In accordance with an aspect of the present invention, there is provided a print-data processing method of performing a predetermined transforming process on print-data and transmitting the transformed print-data to a connected printing device, including the steps of: a) setting a print-mode; b) receiving the print-mode; c) performing a predetermined transforming process on the print-data according to the received print-mode; and d) transmitting the transformed print-data to the printing device.

The print-data processing method may further include the step of displaying the received print-mode.

The print-data processing method may further include the step of receiving one of a print confirmation command for printing the transformed print-data according to the displayed print-mode and a print cancellation command for canceling printing of the transformed print-data according to the displayed print-mode.

The transforming process and the transmitting process of the transformed print-data may be not performed when the print cancellation command is inputted in the step of receiving.

The print-mode may include a color print-mode for allowing color printing and a mono print-mode for not allowing color printing and allowing black and white printing, and in step c), if the received print-mode is the mono print-mode and the print-data is color print-data, the color print-data is transformed to print-data that is suitable for the mono print-mode.

The print-mode preferably includes a high-quality print-mode for allowing high-quality printing of the print-data on a high-quality paper and a normal print-mode for not allowing high-quality printing of the print-data on the high-quality paper and allowing normally printing the print-data on a normal paper, and in the step c), if the received print-mode is the normal print-mode and the print-data is high-quality print-data, the high-quality print-data is transformed to print-data that is suitable for the normal print-mode.

The print-mode preferably includes a high-resolution print-mode for allowing high-resolution printing and a low-resolution print-mode for not allowing high-resolution printing and allowing low-resolution printing, and in the step c), if the received print-mode is the low-resolution print-mode and the print-data is high-resolution print-data, the high-resolution print-data is transformed into print-data that is suitable for the low-resolution print-mode.

In step a), the print-mode is preferably set through one of the printing device, a printing data processing apparatus and an external device connected to the printing device.

The printing data processing apparatus may be one of a personal computer (PC), a personal digital assistant (PDA), a mobile phone, a digital camera or camcorder, or any other suitable device.

In accordance with another aspect of the present invention, there is provided a print-data processing apparatus, that includes a communication interfacing unit for receiving a set print-mode; and a controlling unit for performing a predetermined transforming process on print-data according to the received print-mode in order to print the print-data according to the received print-mode and transmitting the transformed print-data to an external printing device through the communication interfacing unit.

The print-data processing apparatus preferably also includes a displaying unit for displaying the received print-mode.

The print-data processing apparatus preferably includes an inputting unit for one of a print confirmation command for printing the transformed print-data according to the displayed print-mode and a print cancellation command for canceling printing of the transformed print-data according to the displayed print-mode.

The controlling unit preferably does not perform the transforming process and the transmitting process of the transformed print-data when the print cancellation command is received.

The print-mode preferably includes a color print-mode for allowing color printing and a mono print-mode for not allowing color printing and allowing black and white printing, and the controlling unit preferably transforms the color print-data to print-data suitable for the mono print-mode when the received print-mode is the mono print-mode and the print-data is color print-data.

The print-mode preferably includes a high-quality print-mode for allowing high-quality printing of the print-data on a high-quality paper and a normal print-mode for not allowing high-quality printing of the print-data on the high-quality paper and allowing normal printing of the print-data on a normal paper. The controlling unit preferably transforms the high-quality print-data to print-data that is suitable for the normal print-mode when the received print-mode is the normal print-mode and the print-data is high-quality print-data.

The print-mode preferably includes a high-resolution print-mode for allowing high-resolution printing and a low-resolution print-mode for not allowing high-resolution printing and allowing low-resolution printing. The controlling unit preferably transforms the high-resolution print-data to print-data that is suitable for the low-resolution print-mode when the received print-mode is the low-resolution print-mode and the print-data is high-resolution print-data.

### BRIEF DESCRIPTION OF THE DRAWINGS

The above aspects and features of embodiments of the present invention will be more apparent with reference to the accompanying drawings, in which:

FIG. 1 is a block diagram illustrating a printing system according to an embodiment of the present invention;

FIG. 2 is a block diagram depicting a personal computer (PC) shown in FIG. 1;

FIG. 3 is a flowchart showing a method of processing print-data based on a print-mode set on a printing device according to an embodiment of the present invention;

FIG. 4 is a flowchart illustrating a method of processing print-data based on a print-mode set on a printing device according to an embodiment of the present invention; and

FIG. 5 is a flowchart illustrating a method of processing print-data based on a print-mode set on a printing device according to an embodiment of the present invention.

Throughout the drawings, like reference numbers will be understood to refer to like elements, features and structures.

### DETAILED DESCRIPTION OF EXEMPLARY EMBODIMENTS

Exemplary embodiments of the present invention will now be described in greater detail with reference to the accompanying drawings.

The matters defined in the following description are provided to assist in a comprehensive understanding of the invention. Thus, it should be apparent that various changes and modifications to the exemplary embodiments described herein can be made without departing from the scope and spirit of the present invention. Also, descriptions of well-known functions and constructions are omitted for clarity and conciseness.

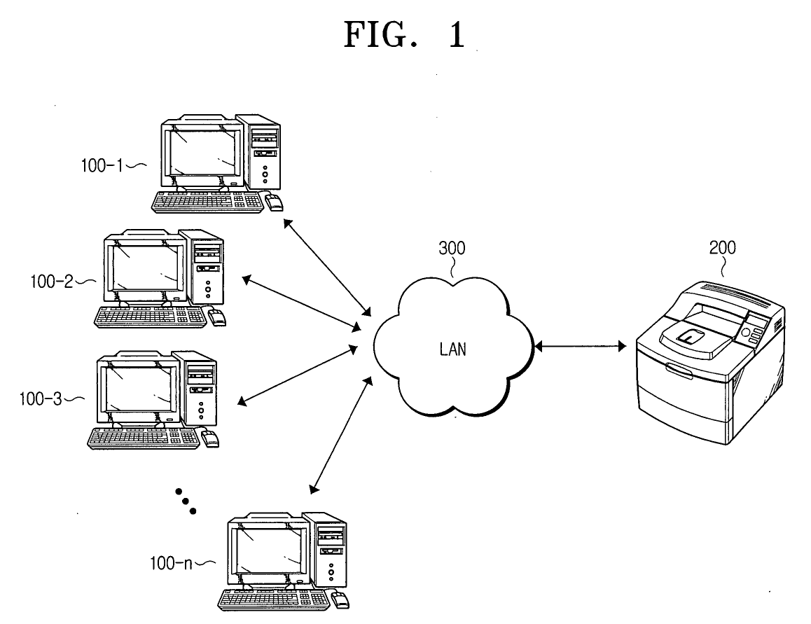

FIG. 1 is a block diagram of a printing system in accordance with an exemplary embodiment of the present invention. Referring to FIG. 1, the printing system includes personal computers (PC) 100-1 to 100-n, a printing device 200, and a local area network 300 for connecting the PCs 100-1 to 100-n to the printing device 200.

The PCs 100-1 to 100-n generate or modify print-data which is an object to be printed, and perform a predetermined transforming process on the generated or modified print-data. The PCs 100-1 to 100-n also transmit the transformed print-data to the printing device 200.

The printing device 200 receives the transformed print-data from the PCs 100-1 to 100-n and prints the received print-data. The printing device 200 is also used to set a print-mode. The print-mode may be set by using functional keys provided on the printing device 200 or a user interface provided for the printing device 200.

There are preferably many print-modes provided. For example, the print-modes may include a color print-mode for allowing color printing and a mono print-mode for allowing black and white printing only. The print-modes may also include a high-quality print-mode for allowing high-quality printing on a high-quality paper and a normal print-mode for allowing normal printing only. Moreover, the print-mode may include a high-resolution print-mode for allowing high-resolution printing and a low-resolution print-mode for allowing low-resolution printing only. Among the above mentioned print-modes, the color print-mode, the high-quality print-mode, and the high-resolution print-mode use toner or ink significantly more than the mono print-mode, the normal print-mode and the low-resolution print-mode.

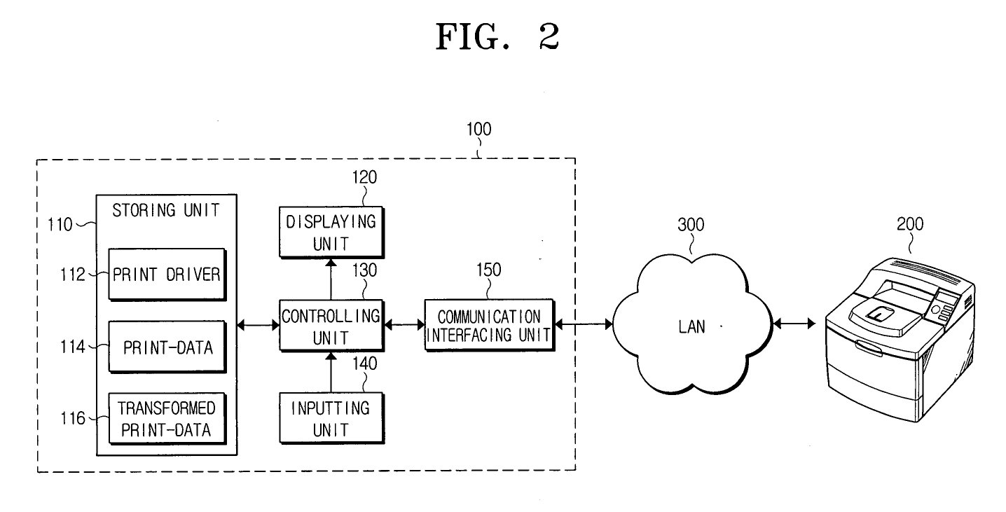

Hereinafter, an exemplary embodiment of the printing system will be explained in detail with reference to FIG. 2.

FIG. 2 is a detailed diagram of a personal computer (PC) shown in FIG. 1. Since the printing system can be implemented by using identical personal computers, only one PC 100 is illustrated in FIG. 2.

Referring to FIG. 2, the personal computer (PC) 100 includes a storing unit 110, a displaying unit 120, a controlling unit 130, an inputting unit 140 and a communication interfacing unit 150.

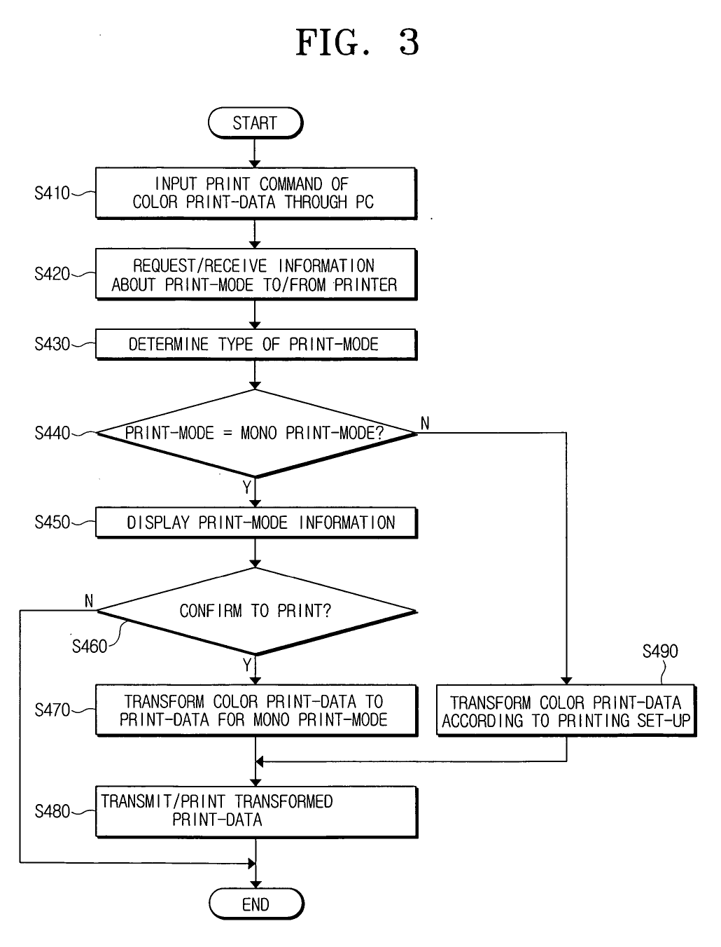

The storing unit 110 is a storage medium for storing data, driving programs and application programs used in the PC 100. A hard disk drive is generally used as the storing unit 110, but the invention is not limited thereto. The storing unit 110 stores a print driver 112 which is a program for driving the printing device 200. The print driver 112 is produced to perform an algorithm as shown in FIGS. 3 to 5.

The storing unit 110 also stores the generated/modified print-data 114 which is generated and/or modified by a user and transformed print-data 116, which is transformed by performing a predetermined data-transforming process.

The displaying unit 120 displays predetermined information. A monitor is generally used as the displaying unit 120. The input unit 140 is a user interface for receiving a driving command from a user and transferring the received driving command to the controlling unit 130. A keyboard or a mouse is commonly used as the inputting unit 140. The inputting unit 140 is used to input a printing command and to set the printing set-up.

The print-mode and the printing set-up are a printing method of a printing device 200 set by a user. However, they are different because the print-mode is a printing method of the printing device set through the printing device 200 and the printing set-up is the printing method of the printing device set through the PC 100.

Since the print-mode is set by the printing device 200, the print-mode is commonly applied to all PCs connected to the printing device 200. In contrast, the printing set-up is only applied to a particular PC because the printing set-up is set through the PC. That is, in the printing system shown in FIG. 1, a print-mode set by the printing device 200 is commonly applied to all PCs 100-1 to 100-n. However, a printing set-up set by a first PC 100-1 is applied to the first PC 100-1 only.

Referring to FIG. 2 again, the communication interfacing unit 150 transmits the transformed print-data 116 stored in the storing unit 110 to the printing device 200 through the LAN 300 according to the control of the controlling unit 130. The communication interfacing unit 150 also receives information about a print-mode from the printing device 200 through the LAN 300 and transfers the received information to the controlling unit 130.

The controlling unit 130 controls general operations of the PC 100 according to driving commands transferred through the inputting unit 140. Specially, the controlling 130 performs a predetermined transforming process of the print-data 114 according to the print-mode by loading the printer driver 112 and stores the transformed data 116 in the storing unit 110 for printing the print-data based on the print-mode. The printer driver 112 performs a printing operation according to an algorithm as shown in FIGS. 3 to 5, as will be described in further detail below.

FIG. 3 is a flowchart showing a method of processing print-data according to a print-mode set on a printing device for printing the print-data based on the print-mode in accordance with an embodiment of the present invention. In the exemplary embodiment, it is assumed that there are two print-modes provided, which are a color print-mode and a mono print-mode, as the print-mode to be set to the printing device 200. As described above, the color print-mode is a mode allowing color printing and the mono print-mode is a mode allowing black and white printing only.

Referring to FIG. 3, a user inputs a print command for printing color print-data 112 stored in the storing unit 110 through the inputting unit 140 prepared on the PC 100 at step S410. The print command is transferred to the controlling unit 130.

The controlling unit 130 requests the printing device 200 to transmit information about a print-mode set on the printing device 200 through the communication interfacing unit 150 and receives the information from the printing device 200 through the communication interfacing unit 150 at step S420.

The controlling unit 130 determines a type of the print-mode based on the received information at step S430.

If the print-mode is the mono print-mode at step S440, the controlling unit 130 displays information about the print-mode on the displaying unit 120 at step S450. Accordingly, a text message indicating that the print-mode is set as the mono print-mode is displayed on the displaying unit 120. The message provides notice to the user that the printing device 200 only performs black and white printing for color print-data and asks a user to confirm whether to print the color print-data in mono print mode.

When the user inputs a print confirmation command through the inputting unit 140 at step S460, the controlling unit 130 transforms the color print-data to mono print-data for printing the color print-data based on the mono print-mode at step S470 and stores the transformed mono print-data in the storing unit 110.

While performing the step S470, the printing set-up is not considered. That is, if the print-mode is set as the mono print-mode, the controlling unit 130 transforms the color print-data to the mono print-data for black and white printing although the printing set-up is set as the color printing set-up. That is, the print-mode has higher priority than the printing set-up.

The controlling unit 130 transmits the transformed mono print-data stored in the storing unit 110 to the printing device 200 through the communication interfacing unit 150. The printing device 200 receives the print-data transmitted from the PC 100 and prints the received print-data at step S480.

When the user does not input the print confirmation command, that is, the user cancels printing the color print-data based on the mono print-mode at step S460, the controlling unit 130 does not perform the transforming process or the transmitting process. That is, the printing operation is terminated without printing the color print-data.

Meanwhile, if the print-mode is determined to be a color print-mode at step S430, the controlling unit 130 transforms the color print-data 114 to be proper to a printing set-up at step S490. In more detail, when the printing set-up is the color printing set-up, the controlling unit 130 transforms the color print-data to print-data suitable to the color printing set-up. When the printing set-up is the mono printing set-up, the controlling unit 130 transforms the color print-data to print-data that is suitable for the mono printing set-up. After transforming the print-data, the step S480 is performed.

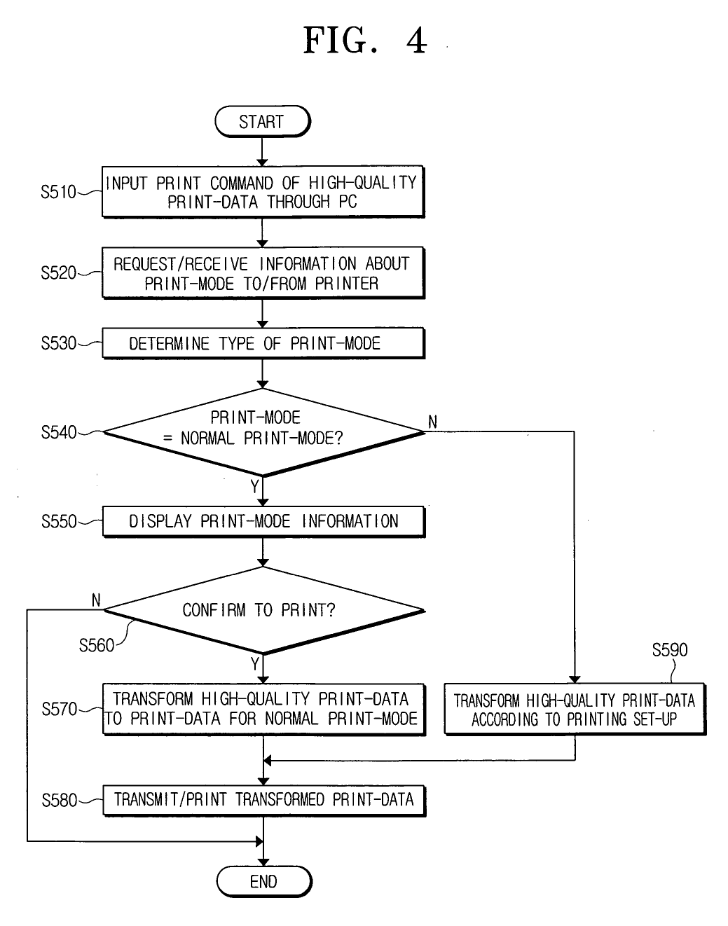

FIG. 4 is a flowchart illustrating a method for processing print-data based on a print-mode set on a printing device in accordance with another embodiment of the present invention. In the exemplary embodiment, it is assumed that there are two print-modes provided, which are a high-quality print-mode and a normal print-mode, as the print-mode to be set to the printing device 200. As described above, the high-quality print-mode is a mode allowing high-quality printing on a high-quality paper and the normal print-mode is a mode allowing normal printing only.

Which print-mode is set to the printer 200, may be determined by selecting trays containing each type of print paper. For example, when the tray containing high-quality paper is selected through the printer 200, it is determined that ‘high-quality printing’ mode is set. Likewise, when the tray containing normal-quality paper is selected through the printer 200, it is determined that ‘normal-quality printing’ mode is set.

Referring to FIG. 4, a user inputs a print command for printing high-quality print-data 112 stored in the storing unit 110 through the inputting unit 140 prepared on the PC 100 at step S510. The print command is transferred to the controlling unit 130.

The controlling unit 130 requests the printing device 200 to transmit information about a print-mode set on the printing device 200 through the communication interfacing unit 150 and receives the information from the printing device 200 through the communication interfacing unit 150 at step S520.

The controlling unit 130 determines a type of the print-mode based on the received information at step S530.

If the print-mode is the normal print-mode at step S540, the controlling unit 130 displays information about the print-mode on the displaying unit 120 at step S550. Accordingly, a text message indicating that the print-mode is set as the normal print-mode is displayed on the displaying unit 120. This provides notice to the user that the printing device 200 only performs normal printing and asks the user to confirm normal printing of the high-quality print-data on the normal paper based on the normal print-mode.

When the user inputs a print confirmation command through the inputting unit 140 at step S560, the controlling unit 130 transforms the high-quality print-data 114 to correspond with normal printing at step S570 and stores the transformed print-data 116 in the storing unit 110.

While performing step S570, the printing set-up is not considered. That is, if the print-mode is set as the normal print-mode, the controlling unit 130 transforms the print-data to correspond with normal printing although the printing set-up is set as the high-quality printing set-up. That is, the print-mode has higher priority than the printing set-up.

The controlling unit 130 transmits the transformed print-data 116 for normal printing stored in the storing unit 110 to the printing device 200 through the communication interfacing unit 150. The printing device 200 receives the print-data transmitted from the PC 100 and prints the received print-data at step S580.

When the user does not input the print confirmation command, that is, the user cancels printing the print-data based on the normal print-mode at step S560, the controlling unit 130 does not perform the transforming process or the transmitting process. That is, the printing operation is terminated without printing the print-data.

Meanwhile, if the print-mode is determined as a high-quality print-mode at step S530, the controlling unit 130 transforms the high-quality print-data 114 to correspond with a printing set-up at step S590. In other words, when the printing set-up is a high-quality printing set-up, the controlling unit 130 transforms the high-quality print-data to print-data to be suitable for the high-quality printing set-up. When the printing set-up is a normal printing set-up, the controlling unit 130 transforms the high-quality print-data to print-data to be suitable for the normal printing set-up. After transforming the print-data, the step S580 is performed.

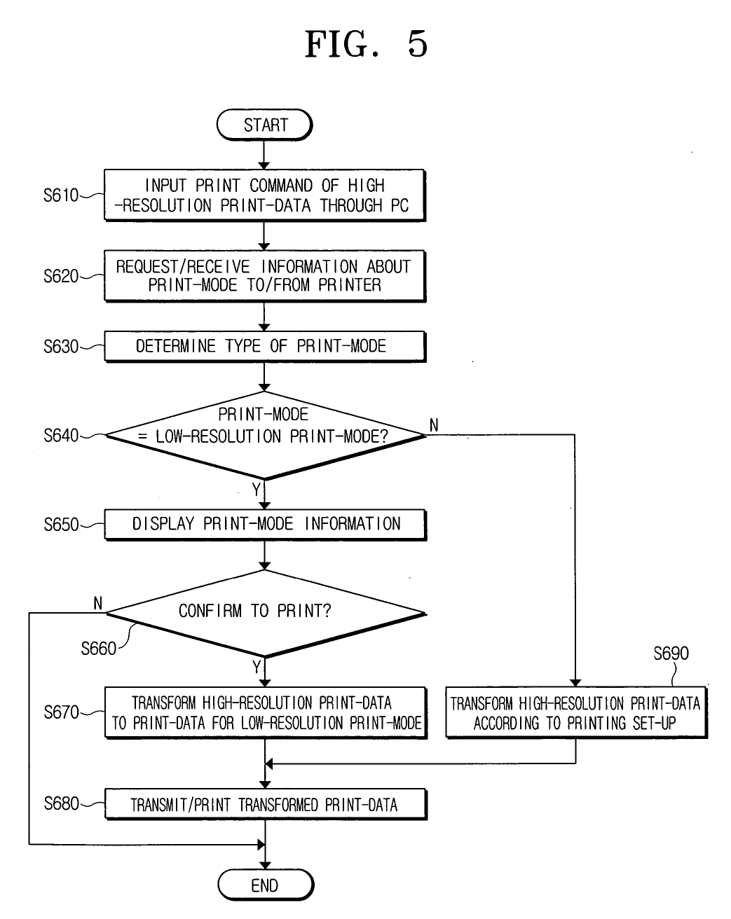

FIG. 5 is a flowchart illustrating a method for processing print-data based on a print-mode set on a printing device in accordance with another embodiment of the present invention. In the exemplary embodiment, it is assumed that there are two print-modes provided, which are a high-resolution print-mode and a low-resolution print-mode, as the print-mode to be set to the printing device 200. As described above, the high-resolution print-mode is a mode allowing high-resolution printing and the low-resolution print-mode is a mode allowing low-resolution printing only.

Referring FIG. 5, a user inputs a print command for printing a high-resolution print-data 112 stored in the storing unit 110 through the inputting unit 140 prepared on the PC 100 at step S610. The print command is transferred to the controlling unit 130.

The controlling unit 130 requests the printing device 200 to transmit information about a print-mode set on the printing device 200 through the communication interfacing unit 150 and receives the information from the printing device 200 through the communication interfacing unit 150 at step S620.

The controlling unit 130 determines a type of the print-mode based on the received information about the print-mode at step S630.

If the print-mode is the low-resolution print-mode at step S640, the controlling unit 130 displays information about the print-mode on the displaying unit 120 at step S650. Accordingly, a text message indicating that the print-mode is set as the low-resolution print-mode is displayed on the displaying unit 120 for the message provides notice to the user that the printing device 200 only performs low-resolution printing and asks the user to confirm printing the high-resolution print-data based on the low-resolution print-mode.

When the user inputs a print confirmation command through the inputting unit 140 at step S660, the controlling unit 130 transforms the high-resolution print-data 114 to correspond to the low-resolution printing at step S670 and stores the transformed print-data 116 in the storing unit 110.

While performing the step S670, the printing set-up is not considered. That is, if the print-mode is set as the low-resolution print-mode, the controlling unit 130 transforms the print-data to be proper for low-resolution printing although the printing set-up is set as a high-resolution printing set-up. That is, the print-mode has higher priority than the printing set-up.

The controlling unit 130 transmits the transformed print-data 116 for low-resolution printing stored in the storing unit 110 to the printing device 200 through the communication interfacing unit 150. The printing device 200 receives the print-data transmitted from the PC 100 and prints the received print-data at step S680.

When the user does not input a print confirmation command, that is, the user cancels printing the high-resolution print-data based on the low-resolution print-mode at step S660, the controlling unit 130 does not perform the transforming process or the transmitting process. That is, the printing operation is terminated without printing the print-data.

Meanwhile, if the print-mode is determined as a high-resolution print-mode at step S640, the controlling unit 130 transforms the high-resolution print-data 114 to correspond to a printing set-up at step S690. In other word, when the printing set-up is the high-resolution printing set-up, the controlling unit 130 transforms the high-resolution print-data to print-data to be suitable to the high-resolution printing set-up. When the printing set-up is the low-resolution printing set-up, the controlling unit 130 transforms the high-resolution print-data to print-data to be suitable to the low-resolution printing set-up. After transforming the print-data, the step S680 is performed.

Throughout the foregoing description, methods of processing print-data based on a print-mode in accordance with embodiments of the present invention have been described. However, embodiments of the present invention can selectively unifying the embodiments described herein. Furthermore, embodiments of the present invention can be applied to other print-modes besides of the above mentioned print-modes.

In the exemplary embodiments, the print-mode is set through the printing device 200, but it should be understood that the present invention is not limited thereto. The print-mode may be set by an external device, such as a management server or a remote control panel (RCP) which is connected to the printing device 200 or the PC 100.

Also, any apparatus capable of performing a transforming process for print-data can be used in place of the PCs 100-1 to 100-n. The apparatus capable of performing the transforming process may include a personal digital assistant, a mobile phone, a digital camera or camcorder, or any other suitable device.

Furthermore, any apparatus capable of printing transformed print-data can be used as the printing device 200. The apparatus capable of printing the transformed print-data may include a printer or a multifunctional device capable of printing, copying and scanning, or any other suitable device.

Moreover, any network capable of connecting the PCs 100-1 to 100-n to the printing device 200 can be used as the LAN 300. The network may include an intranet and the Internet, or any other suitable network.

As described above, according to exemplary embodiments of the present invention, the print-data is transformed to correspond to the print-mode set on the printing device and then the transformed print-data is transmitted to the printing device. Accordingly, embodiments of the present invention advantageously prevent the printing device from performing faulty printing operations which are caused by performing the transforming process of the print-data in the printing device. That is, when the print-mode set on the printing device requires transformation of the print-data and the transforming process requires mass computation, the transforming process is performed by the PC in the present embodiments of the present invention. Therefore, the printing device is prevented from faulty printing of the print-data caused by overload of a processor of the printing device.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A print-data processing method for performing a predetermined transforming process on print-data and transmitting the transformed print-data to a connected printing device, comprising the steps of:
a) setting a print-mode;
b) receiving the print-mode;
c) performing a predetermined transforming process on the print-data according to the received print-mode; and
d) transmitting the transformed print-data to the printing device.

2. The print-data processing method of claim 1, further comprising the step of displaying the received print-mode.

3. The print-data processing method of claim 2, further comprising the step of receiving one of a print confirmation command for printing the transformed print-data according to the displayed print-mode and a print cancellation command for canceling printing the transformed print-data according to the displayed print-mode.

4. The print-data processing method of claim 3, wherein the transforming process and the transmitting process of the transformed print-data are not performed when the print cancellation command is input in the step of receiving.

5. The print-data processing method of claim 1, wherein the print-mode includes a color print-mode for allowing color printing and a mono print-mode for not allowing the color printing and allowing black and white printing, and in step c), if the received print-mode is the mono print-mode and the print-data is color print-data, the color print-data is transformed to mono print-data corresponding to the mono print-mode.

6. The print-data processing method of claim 1, wherein the print-mode includes a high-quality print-mode for allowing to high-quality print the print-data on a high-quality paper and a normal print-mode for not allowing to high-quality print the print-data on the high-quality paper and allowing normal printing of the print-data on a normal paper, and in step c), if the received print-mode is the normal print-mode and the print-data is high-quality print-data, the high-quality print-data is transformed to normal print-data corresponding to the normal print-mode.

7. The print-data processing method of claim 1, wherein the print-mode includes a high-resolution print-mode for allowing high-resolution printing and a low-resolution print-mode for not allowing to high-resolution printing and allowing low-resolution printing, and in step c), if the received print-mode is the low-resolution print-mode and the print-data is high-resolution print-data, the high-resolution print-data is transformed to low-resolution print-data corresponding to the low-resolution print-mode.

8. The print-data processing method of claim 1, wherein in step a), the print-mode is set through one of the printing device, a printing data processing apparatus and an external device connected to the printing device.

9. The print-data processing method of claim 1, wherein the printing data processing apparatus is one of a personal computer (PC), a personal digital assistant (PDA), a mobile phone, a digital camera and a digital camcorder.

10. A print-data processing apparatus, comprising:
a communication interfacing unit for receiving a set print-mode; and
a controlling unit for performing a predetermined transforming process on print-data according to the received print-mode in order to print the print-data according to the received print-mode and transmitting the transformed print-data to an external printing device through the communication interfacing unit.

11. The print-data processing apparatus of claim 10, further comprising a displaying unit for displaying the received print-mode.

12. The print-data processing apparatus of claim 11, further comprising an inputting unit for inputting one of a print confirmation command for printing the transformed print-data according to the displayed print-mode and a print cancellation command for canceling printing of the transformed print-data according to the displayed print-mode.

13. The print-data processing apparatus of claim 12, wherein the controlling unit does not perform the transforming process and the transmitting process of the transformed print-data when the print cancellation command is inputted.

14. The print-data processing apparatus of claim 10, wherein the print-mode includes a color print-mode for allowing color printing and a mono print-mode for not allowing the color printing and allowing black and white printing, and the controlling unit transforms the color print-data to mono print-data corresponding to the mono print-mode when the received print-mode is the mono print-mode and the print-data is color print-data.

15. The print-data processing apparatus of claim 10, wherein the print-mode includes a high-quality print-mode for allowing to high-quality print the print-data on a high-quality paper and a normal print-mode for not allowing to high-quality print the print-data on the high-quality paper and allowing normal printing of the print-data on a normal paper, and the controlling unit transforms the high-quality print-data to normal print-data corresponding to the normal print-mode when the received print-mode is the normal print-mode and the print-data is high-quality print-data.

16. The print-data processing apparatus of claim 10, wherein the print-mode includes a high-resolution print-mode for allowing high-resolution printing and a low-resolution print-mode for not allowing to high-resolution printing and allowing low-resolution printing, and the controlling unit transforms the high-resolution print-data to low-resolution print-data corresponding to the low-resolution print-mode when the received print-mode is the low-resolution print-mode and the print-data is high-resolution print-data.
